(19) United States
(12) Patent Application Publication
(10) Pub. No.: US 2009/0326715 A1
(43) Pub. Date: Dec. 31, 2009

(54) Method for Biofuel Life Cycle Assessment

(75) Inventors: Adam Liska, Lincoln, NE (US); Haishun Yang, Lincoln, NE (US); Kenneth Cassman, Lincoln, NE (US); Virgil Ray Bremer, Lincoln, NE (US); Terry Klopfenstein, Lincoln, NE (US); Galen Erickson, Lincoln, NE (US)

Correspondence Address: University of Nebraska-Lincoln;Office of Technology Development, 1320 Q Street, Lincoln, NE, 68588-0467, US

(73) Assignee: THE BOARD OF REGENTS OF THE UNIVERSITY OF NEBRASKA, Lincoln, NE (US)

(21) Appl. No.: 12/487,301

(22) Filed: Jun. 18, 2009

Related U.S. Application Data
(60) Provisional application No. 61/132,685, filed on Jun. 20, 2008.

(51) Int. Cl. G05B 21/00

(52) U.S. Cl. 700/266

(57) ABSTRACT

A method for calculating the greenhouse gas (GHG) emissions, energy efficiency, and natural resource requirements of a biofuel production system, using a life cycle assessment of biofuel production from the creation of material inputs to finished products, and producing a GHG emissions inventory from fossil fuels and a few key non-fossil fuel GHG emissions in the production life cycle.

### CROSS REFERENCE TO RELATED APPLICATIONS

This application claims priority under 35 U.S.C. §119(e) of U.S. provisional application Ser. No. 61/132,685, filed Jun. 20, 2008.

### FEDERALLY SPONSORED RESEARCH OR DEVELOPMENT

This invention was made with government support under Grant No. DE-FG02-03ER63639 awarded by DOE. The government has certain rights in the invention.

### ABSTRACT

A method for calculating the greenhouse gas (GHG) emissions, energy efficiency, and natural resource requirements of a biofuel production system, using a life cycle assessment of biofuel production from the creation of material inputs to finished products, and producing a GHG emissions inventory from fossil fuels and a few key non-fossil fuel GHG emissions in the production life cycle.

### BACKGROUND OF THE INVENTION

Biofuels, specifically ethanol, have moved to the forefront of the public's awareness in recent years due to a move toward environmentally friendly energy and the desire to be less dependent on foreign oil. This interest in alternative energy resources has not been without controversy. Many believe that ethanol is an inefficient alternative to gasoline, saying it takes more energy to produce the ethanol than the ethanol product provides. Scientific methodology to analyze the production of ethanol and other biofuels has been of little help, as a wide variety of methods employing vastly different metrics and inputs have abounded. The results of these studies have been widely divergent, with findings ranging from substantial net energy loss to a modest net energy gain. One study recently attempted to reconcile the divergent results of previous studies with an analysis of six prominent studies on the subject. The authors applied a standard framework that equalized system boundaries, input energy parameter values and conversion efficiencies across the six studies and estimated that corn-ethanol had a small, but positive, NER of 1.2.

There are several reasons why these results vary so widely, and thus why there is so much uncertainty as to whether biofuels should be pursued as an alternative energy source. First, the current methods perform the analysis on an industry-wide basis rather than on an individual system level. Such an approach often relies on inaccurate data and combines efficient and inefficient systems in a process that does not sufficiently characterize the most efficient biofuel producers. Most methods rely on obsolete data sets, and thus cannot model improvements in crop yields and production efficiencies, or the improved designs and technologies present in newer biorefineries. Due to these shortcomings, the previously-used methods are inaccurate and incapable of adaptation to changes and improvements in cropping practices and industry infrastructure.

An effect of the push for environmentally friendly energy sources is state and federal legislation that has been enacted for regulation of the life cycle emissions from biofuels. Rising atmospheric concentrations of CO₂ and other greenhouse gases (GHGs), and the associated threat of climate change has led to global discussion about policies and incentives to reverse these trends. Because of the large variation in performance and the resulting GHG emissions from different biofuel production systems, there is a need for a standardized protocol and tool to estimate GHG emission reductions for biofuels produced by a specific production facility and its associated feedstock supply zone. Such a tool would provide a means for certifying the GHG emissions and carbon credits attributable to a given biofuel system and allow monetizing any credits for emerging GHG emissions markets, such as the Chicago Climate Exchange. Moreover, biofuel producers need to verify GHG reductions to export into markets that require life cycle GHG emissions certification, such as the state of California. Other states on the west and east coasts also plan to adopt similar emissions requirements as those in California for importation of biofuel. At the federal level, biofuel production must meet GHG reduction requirements set by the Energy Independence and Security Act of 2007: 20% for corn-ethanol, 60% for cellulosic ethanol, and 50% for other advanced biofuel. Verification of life-cycle emissions reductions will require a standardized certification system based on established methods for quantitative life-cycle analysis (LCA). The certification tool or procedure would need to be flexible, robust, accurate, and user-friendly so that it could be widely used by C-credit investors and biofuel industry professionals to determine the GHG intensity of their biofuel and the value of GHG emissions reductions for a specific biofuel facility and feedstock supply.

The U.S. Supreme Court has set the foundation for GHG emissions regulation and trading in its Apr. 2, 2007 decision that classifies GHG as pollutants and gives authority to the Environmental Protection Agency under the Clean Air Act for regulating their emissions. If GHG emission reductions at the national level are mandated by legislation, as they are in Europe under the European Union's Emissions Trading Scheme (ETS), an emissions cap-and-trade system could add an additional income stream to the biofuel industry. In fact, the US Congress is currently debating legislation that would create such a cap-and-trade program to regulate emissions. Acceptance and expansion of the European Union's emissions trading market through the ETS has been constrained by a lack of facility-specific data and a scarcity of sector-specific emission prediction models. With the development of certification tools, such a void could be filled in the US.

The goal of reducing net GHG emissions for an industrial sector requires a change in practices that lead to a measurable difference in emissions. This reduction must include direct and indirect GHG emissions generated across the life cycle of the production of transportation fuels. Only by evaluating the production life cycle of alternative fuels can one determine that such practices are causing a measurable reduction in GHG emissions. For example, approximately 50-80% of life-cycle fuel emissions are from the biorefinery, while the other 20-50% of emissions come from crop production. An analysis of only the biorefinery would provide an incomplete conclusion concerning life cycle efficiency. Thus, models are necessary to evaluate the entire scope of fossil fuel use in biofuel production, and the associated emissions to determine that they do not exceed the emissions of the conventional fuel which it will replace. The standard emissions level from the conventional fuel (gasoline) is the baseline that alternative fuels must not exceed, and which alternative fuels must strive to reduce substantially.

The present invention provides two unique applications related to these emerging regulatory requirements: 1) an accurate assessment tool to extend emissions trading to corn grain-ethanol producers, and other biofuel producers, and 2) a software framework for operationalizing state and federal life cycle emissions standards, as applied to biofuel producers. In comparison to emissions models for criteria pollutants and GHGs which necessitate the monitoring of the air quality compliance for individual ethanol facilities, the calculation of GHG emissions credits in the present invention estimates the gross GHG emissions from fossil fuels and a few key non-fossil fuel emissions as an inventory of distributed GHG emissions. An example of a non-fossil fuel emission is nitrous oxide from nitrogen fertilizer applied to corn cropping systems. By making an inventory of fossil fuel use in the biofuel production life cycle, the gathering of emissions data would not inhibit implementation of such cap-and-trade schemes, whereas actual emissions monitoring is both labor and capital intensive, and doesn't consider on farm fossil fuel use. The present invention offers a more cost-effective and complete alternative. An emissions trading scheme for the biofuels industry would require broad participation of biofuel producers, and limited labor and capital expenses to ensure program viability. Such a scheme for producers would also encourage industry expansion, reduce the need for industry subsidies, and reduce industry emissions by favoring efficient producers.

It is, accordingly, an object of the present invention to provide an improved methodology for analyzing the life cycle GHG emissions, energy efficiency, and natural resource requirements of an individual biofuel systems production facility.

It is also an object of the present invention to provide a method for analysis based on local characteristics and variables rather than nationwide averages.

It is another object of the present invention to provide a comprehensive and standardized method for determining life cycle GHG emissions for environmental regulation compliance that can be calibrated to state, federal, and international emissions parameters and emission factors.

It is still further an object of the present invention to provide a method to allow for the optimization of biofuel production facilities based on comparing different scenarios of production, and for aiding biorefinery operators in identifying best management practices to reduce GHG emissions.

It is also an object of the present invention to provide a method to model changes and improvements in the machinery and processes involved in biofuel energy systems, both on farm and at the biorefinery.

It is still further an object of the present invention to provide customizable default scenarios to allow users to modify regional data averages to fit their individual needs.

It is also an object of the present invention to provide a method to evaluate state and federal regulatory procedures for life cycle GHG emissions, and enable biofuel producers to independently critique and validate governmental regulatory methods.

### BRIEF SUMMARY OF THE INVENTION

The present invention is directed to a method for analysis of an individual biofuel production system to determine its life cycle GHG emissions, net energy efficiency, and natural resource requirements. The method is comprises three steps. The first step is the receiving of data related to the production parameters of a crop used as a biofuel feedstock, specific characteristics of a biofuel refining system, and use of co-products to feed livestock into a computer system. The next step is the determination of net energy efficiency values, life cycle GHG emissions, and natural resource requirements. The last step involves displaying these values in the computer system. The method works on an individual production system basis because it allows the user to input the conditions and variables specific to a given facility and its surrounding production zone. This method for comprehensive individual system analysis is vital because it will allow for determining environmental impacts to meet state and federal regulatory requirements. It will also allow for comparison of different methods of production, allowing the user to optimize their production facility. The method can account for changes and improvements in biofuel production systems, and perform sensitivity analyses that identify technology options with the greatest potential impact on life cycle GHG emissions reductions, and energy yield and efficiency. The individual system basis methodology is also important because it uses the local cropping system for its input data, rather than a nationwide average, which is important to get an accurate representation of the efficiency of individual systems.

### DETAILED DESCRIPTION OF THE INVENTION

The present invention will now be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will convey the scope of the invention to those skilled in the art.

The instant invention provides a method of determining the energy efficiency, natural resource requirements, and life cycle GHG emissions of a biofuel production system. The method takes into account a wide range of variables including at least crop production parameters, characteristics of the actual production facility, and the effect of using co-products from the process for other purposes such as feed for cattle. The method may optionally also account for the effect of anaerobic digestion, which is the effect of generating methane from feedlot manure for use as an energy source.

The method provided herein requires certain data to determine the energy efficiency, natural resource requirements, and life cycle GHG emissions of a biofuel production system. In the preferable embodiment, that data relating to crop production, biofuel system characteristics, and co-product usage is provided by a user of the method such that the data relates to the conditions of a specific biofuel production system. This allows the analysis to be specific, and accurately tailored for an individual facility. It is also conceived that a user may not want or be able to provide all of the necessary data to the system. Therefore, the method may also be used with certain pre-assembled reference data sets that represent average conditions for a variety of crop production geographical areas, biofuel system characteristics, co-product usage situations, and other production variables. For example, a data set could be used that corresponds either to a cropping system representing the USA Midwest average, an Iowa average, a Nebraska average, or a progressive cropping average. The biorefinery characteristics could correspond to either a natural gas or coal powered system, and also be tailored to a regional average. The co-product production could be configured for dry, modified-wet, wet, or a mixture of the three types.

The present invention was developed according to the principles of life cycle assessment, which means that the method accounts for the inputs, outputs, and potential environmental impacts of the biofuel production system throughout its entire life cycle. The assessment is a holistic “cradle-to-grave” analysis that quantifies the environmental impact of a process that follows the manufacture of a specific product or products. Life cycle assessment is an incredibly important tool for assessing the environmental sustainability of biofuel systems.

Considerable attention has been given to quantifying the net renewable energy output over the life cycle of biofuel systems that use different conversion technologies and feedstock crops. The net renewable energy output is defined as the gross energy output of a biofuel production system minus the non-renewable fossil energy inputs used in producing the feedstock and its conversion to biofuel and co-products. In contrast, gross energy output is simply the heating value of the fuel produced plus an energy credit for useful co-product outputs.

Net energy output can be quantified by at least three metrics: (i) Net Energy Ratio (NER) is the energy output divided by the energy input and is dimensionless; (ii) Net Energy Value (NEV) is the energy output minus the energy input, in megajoules per liter (MJ L⁻¹); (iii) Net Energy Yield (NEY) is the energy output minus the energy input on a crop feedstock production area basis, usually with units of gigajoules per hectare (GJ ha⁻¹). All three measures evaluate the energy inputs and outputs for the entire biofuel system, including crop production, biofuel conversion, and co-product processing. While NER and NEV typically receive the most attention because they represent a rough surrogate for GHG emissions efficiency, laud use efficiency, and petroleum consumption, they are intensity factors that do not represent the energy productivity of a system because highly efficient systems can have relatively small renewable energy output. In contrast to NER and NEV, NEY combines efficiency and productivity into one value and is therefore a more suitable metric for comparisons of different biofuel production systems, especially if the objective is to reduce dependence on imported petroleum with a limited land base. For purposes of this application, NER, NEV and NEY will be collectively referred to as net energy efficiency values.

Heating values for energy inputs and outputs must be used consistently for accurate energy analysis and comparisons among different studies. The amount of heat released in burning one unit of fuel is called heating value or caloric value. The difference between gross heat of combustion, or Higher Heating Value (HHV), and the net heat of combustion, or Lower Heating Value (LHV), is the latent heat of vaporization of the water produced in the reaction. If during combustion, the water produced is considered a liquid and the heat is in a useable form, HHV is used. When water is considered a vapor in the reaction (as in most internal combustion transportation engines), LHV is used. Most energy studies use LHV exclusively for all fossil fuels used and fuel products produced when biofuel is used as a transportation fuel.

The life cycle energy analysis of corn-ethanol considers the energy used for feedstock production and harvesting, including fossil fuels (primarily diesel) for field operations and electricity for grain drying and irrigation). Crop production energy expenditure also includes upstream costs for the production of fertilizer, pesticides, seed, and the depreciable cost of farm machinery. Energy use in ethanol production includes transportation of grain to the biorefinery, conversion to biofuel, and co-product processing. Energy used for production of materials and construction of the biorefinery facility should also be included and are prorated over the life of the facility in the current method.

A common feature of corn-ethanol life cycle energy studies is that they evaluate the efficiency of the entire U.S. industry, which requires use of average crop and biorefinery performance parameters. For example, the most prominent recent studies used Corn Belt averages for corn yields and production input rates based on state averages prorated by corn production totals in each state. Some studies have used the average performance for dry mills or wet mills exclusively, while others have used an arithmetic average efficiency based on both mill types from a 2001 survey by BBI International. However, according to this survey, wet mills used ˜11% more thermal energy than dry mills, which is a significant portion of life-cycle energy use. Hence, the resulting efficiency of the system depends on which mill type is used in the calculation. In addition, most previous studies have used a mixture of energy inputs for the biorefinery (coal and natural gas) and the average energy use for co-product processing.

There are also different methods for determining co-product processing. Dale (2002) uses an “allocation” procedure to distribute the environmental burdens of the production process to various co-products. An alternative approach used more widely for co-product crediting is the “displacement” method which assumes that co-products from corn-ethanol production substitute for other products that require energy for their production. For corn-ethanol, distiller's grains represent a nutritious animal feed, especially for ruminants such as cattle, and can substitute for soybean meal in livestock diets. Therefore, most life cycle energy analyses give a displacement energy credit for this co-product.

The aggregate approach taken in the aforementioned studies does not evaluate the performance of individual ethanol biorefineries and their corn feedstock supply system, nor do they determine the efficiency of more advanced systems that account for trajectories in crop yields and production efficiencies, or the improved design and technologies of recently built ethanol biorefineries. Instead, these studies provide a “backward-looking” perspective to estimate the energy efficiency of the corn-ethanol industry—relying typically on data that cover a time period 2-10 years prior to the study.

The current method performs an analysis of individual systems to assess the performance of current technology and production practices. Such local analysis can be important for determining environmental impacts to meet emerging regulatory requirements. This method also allows for a “forward-looking” assessment to evaluate expected improvements in biofuel production systems. It can perform sensitivity analyses that identify technology options with the greatest potential impact on energy yield and efficiency, and life cycle GHG emissions reductions. Such forward-looking analyses can help guide the design of future biofuel systems and identify research priorities for the greatest potential impact on increasing the environmental benefits and petroleum replacement of these systems.

By focusing on a single ethanol biorefinery, the current method can analyze the corn-ethanol biofuel production life cycle more accurately than assessments using large-scale averages. Focused assessments can represent a biorefineries' specific technology and efficiency of energy and resource use. The life cycle productivity and efficiency of corn-ethanol systems is also highly dependent on the productivity and efficiency of the regional cropping system. An analysis of local cropping systems is most important, because biorefineries receive a majority of feedstock from local sources, and this trend will also likely continue in the future due to rising commodity prices. Cropping system productivity and efficiency also have significant variability depending upon irrigation practices and location. Biorefinery co-products are also significant commodities that need assessment in the production life cycle, as they are energy rich dietary resources for cattle producers. The current method can be used to determine the combined impact of differences in biorefinery efficiency, cropping system performance, and co-product use on a number of metrics which describe biofuel system performance.

Innovations occur at the level of individual biorefineries and feedstock production systems, which are not detectable within industry averages. For example, a recent study of the industry used a value of 13.9 MJ L⁻¹ for the energy requirements of an average U.S. corn-ethanol biorefinery, which accounted for 71% of life-cycle energy input for corn-ethanol in that study. This estimate of energy efficiency was based on data from 2001 that represented an arithmetic mean energy use for both wet- and dry-mill ethanol plants, average energy inputs from natural gas and coal, and average co-product processing with a majority of biorefineries using energy to dry distiller's grains. In contrast, the energy consumption of a current state-of-the-art corn-ethanol production facility with a dry-grind milling process and natural gas as the main source of energy is estimated at 11.3 MJ L⁻¹, which decreases to 8.2 MJ L⁻¹ when co-product distiller's grains are not dried and fed wet to local livestock. Omitting the drying of distiller's grains results in a 59% reduction in energy use at the biorefinery, compared to previous estimates used in recent studies. The latest industry survey confirms these smaller estimates of energy requirements in recently built dry-mill ethanol production facilities. Biorefinery fossil fuel energy consumption can be further reduced in a “closed-loop” system in which wet distiller's grains from the biorefinery are fed to cattle on-site in an adjacent feedlot where manure and urine are collected in an anaerobic digestion unit to produce methane as a substitute for natural gas in the ethanol plant.

A number of other biorefinery innovations for corn grain-ethanol systems are under development to further increase energy efficiency and reduce fossil fuel use. “Raw”/“cold” starch technology uses enzymes for starch degradation at lower temperatures, which can significantly reduce energy needs and associated life cycle GHG emissions. Corn stover, other crop biomass, or wood chips can be used for co-generation at the biorefinery to replace purchased electricity from a local utility and natural gas or coal-derived energy inputs, reducing life cycle GHG emissions by 52%. Wind and solar energy are potential sources of electricity, and if a biorefinery is located near a nuclear power plant, steam generated from these facilities could be used as a biorefinery energy source. All of these options would substantially increase energy efficiency or reduce life cycle GHG emissions by achieving substantial reductions in fossil fuel energy consumption at the biorefinery, thus contributing to a “greener” corn-ethanol industry. The current method can model and account for these improvements, while previous systems would not be able to.

In addition to technology innovations at the biorefinery, crop yields and production efficiencies have been steadily increasing due to genetic improvement of biofuel crops and advances in agronomic management. For example, US corn yields have been increasing at a linear rate of 112 kg ha⁻¹ yr⁻¹ since 1966 while nitrogen fertilizer efficiency, quantified by the amount of grain produced per unit of applied nitrogen, has risen by nearly 40% since 1980. Irrigation efficiency has improved as farmers respond to the rising cost of water and reductions in water supply from chronic drought. Less efficient water application methods such as furrow or flood irrigation are being replaced by more sophisticated irrigation systems that use low-pressure pivot, linear-move equipment, or even drip irrigation. Because the current method is forward-looking, it can account for the impact of these expected improvements in crop production methods and yields.

There are also large regional differences in crop yields and requirements for production inputs because of differences in soil properties, climate, and access to irrigation. During 2004-2006, for example, the highest average county-level corn yield in the U.S. was 13.7 Mg ha⁻¹, which was 48% greater than the Corn Belt average (9.2 Mg ha⁻¹) and 66% greater than the national average corn yield of 8.2 Mg ha⁻¹. Life cycle assessment of corn-ethanol is further complicated by the fact that corn is produced with irrigation in the drier Western states (e.g. NE, KS, CO) but is almost entirely grown under rainfed conditions in the Easter Corn Belt states. While irrigation increases the energy intensity of crop production, it also increases crop yields and reduces year-to-year variation in yield. For example, in Nebraska, on average, rainfed acres have half the yield of irrigated acres, and one-third of the yield of contest winning plots. Likewise, higher feedlot cattle density in these dry Western states allows the use of wet distiller's grains as feed in local feedlots, which saves energy for drying at the biorefinery and reduces energy for co-product transportation.

Because grain yield and input requirements have a large impact on net energy yield, efficiency, and life cycle GHG emissions of a biofuel system, analysis of individual ethanol biorefineries will require assessment of the actual crop production systems that supply the grain feedstock. To date, however, most life cycle assessments of biofuel systems have been based on average crop yields and crop management statistics for the entire Corn Belt, or on national averages. The present invention is designed to consider such differences in cropping and irrigation practices representing specific regional production efficiencies.

The present invention uses a yearly time period as the basis for determining the average life cycle GHG emissions, energy efficiency, and resource requirements for an individual refinery and feedstock region. This is primarily because the ethanol biorefinery output and state crop production figures are reported on a yearly basis, as are energy input rates for cropping systems, among other input variables that may fluctuate over smaller time frames.

The method presented herein is accomplished with respect to one primary variable, which is the volume of fuel produced by a single ethanol biorefinery in one year. All other values subsequently used in the method should reflect the appropriate spatial and temporal range as is appropriate for these variables.

The first step in the present method is to receive in a computer system at least the following input values for corn production conditions: corn grain (15.5% moisture) in Mg/ha, and Soil C sequestration in Mg C/ha. The required material input values are at least as follows: nitrogen (kg N/ha), manure (kg N/ha), phosphorus (kg P2O5/ha), potassium (kg K2O/ha), lime (kg/ha), herbicides (kg/ha), insecticides (kg/ha), seed (kg/ha), and irrigation water (cm). The fuel consumption can be measured either by fuel type or by field operation. If fuel type is used, the required fuel consumption input values are at least as follows: gasoline (L/ha), diesel (L/ha), LPG (L/ha), natural gas (m³/ha), and electricity (kWh/ha). If field operation is used, the user must specific diesel use by tillage type, as well as what type of irrigation (surface or well water) is used, and the energy type used to power the irrigation (diesel, electric, or natural gas). Another input value for corn production is the amount of depreciable capital energy (MJ/ha). In the ideal embodiment, a user of the system would input these values as they exist for a specific biofuel production system. It is also conceived that reference data sets could be used for some or all of the required input values.

The next step in the present method requires receiving input values in a computer system relating to the ethanol biorefinery itself. The values in this area can be broken down into three categories. First, the required inputs relating to production performance are at least as follows: ethanol production (million L/yr), corn-to-ethanol conversion rate (L/kg), water use (L/L ethanol), production of DDGS-Equivalent [100% DM](kg/L ethanol), and production of DDG-Equivalent [100% DM], (kg/L ethanol). Second, the required inputs relating to energy use are at least as follows: source of thermal energy (natural gas, coal, or biogas), thermal energy for ethanol production (MJ/L), thermal energy for drying DGS (MJ/L), electricity input (kWh/L), and depreciable capital energy (MJ/L). Third, the required inputs for co-product composition are at least as follows: dry DGS (% of total composition), modified DOGS (% of total composition), and wet DGS (% by total composition). The model was designed for these values to be consistent with anhydrous “pure” ethanol, as opposed to denatured ethanol. Again, in the ideal embodiment a user of the system would input these values as they exist for a specific biofuel production system. It is also conceived that reference data sets could be used for some or all of the required input values.

The next step in the present method requires receiving input values relating to the cattle feedlot. The cattle feedlot as a whole can be summarized with an aggregate co-product energy credit (MJ/L ethanol). Alternatively, the feedlot can be broken down into itemized energy and GHG co-product credit, by inputting values relating to cattle performance and transportation of co-product. First, the required inputs for cattle performance are at least as follows: in-weight (kg), out-weight (kg), dry matter intake (kg/day), average daily gain (kg/day), corn diet crude protein (% dry matter), and co-product inclusion level (diet % dry matter). Second, the required inputs relating to transportation of co-product are at least as follows: truck load size (kg), distance of corn haul to lot (km), distance of DGS transport (km), truck fuel efficiency (km/L), and conventional diet feed truck fuel use (L/head/day). Again, in the ideal embodiment a user of the system would input these values as they exist for a specific biofuel production system. It is also conceived that reference data sets could be used for some or all of the required input values.

The present method may also optionally receive in the computer system a fourth category of input relating to an anaerobic digestion system. This accounts for methane generated from manure and urine produced by cattle in the feedlot. The required inputs are at least as follows: volatile fraction (VS/TS, %), crude protein (% of dry matter), reduction in VS by biodigester (%), and treated water (L/head/day). Ideally these values are input by a user as they exist for a specific system, but it is also known that reference data sets could be used for these values.

Once all required inputs are received, the net energy efficiency, natural resource requirements, and life cycle GHG emissions of the biofuel production system are determined by using standard mathematical equations known in the art. These equations are ideally calculated with a computer system. Other resultant values, which are described hereinafter, are also determined. The total grain requirements and required harvest area for the selected biorefinery are determined and displayed to the user of the method. The total quantity of each input is calculated and displayed. Total inputs of fossil fuel energy, and emissions from CO₂, CH₄, N₂O, and CO₂ eq (global warming potential) from each input in crop production are calculated. The percentage energy expenditure for each input is also displayed, with the sum of the input energy expenditures being 100%. These results are then shown ideally in either a bar or pie chart, but it is also conceived that other visual representations of the data could be shown. The bar chart option displays inputs as ordered in rank from highest to lowest. Finally, each energy input and associated GHG emission for crop production is shown as a percentage of the total life cycle energy expenditure.

The invention also displays data related to the ethanol biorefinery component of the model either as absolute total energy (terajoules, TJ), % of crop production, or % of total life cycle. This includes energy inputs for refinery operation, drying distiller's grains, grain transportation from the field to the facility, and the depreciable energy embodied in the facility infrastructure. Total energy use for the facility is displayed either as an absolute amount, percent of biorefinery inputs, or percent of life cycle inputs. Total water requirements and distiller's grains produced are also shown to the user. Cattle feedlot results are displayed for the energy credit for use of distiller's grains in cattle feeding operations in comparison to traditional diets.

What is claimed is:

1. A method of determining the net energy efficiency values of a biofuel production system, comprising the steps of:
receiving data in a computer system for production parameters of a crop used as a biofuel feedstock, specific characteristics of a biofuel refining system, and use of co-products to feed livestock;
determining said net energy efficiency values in a computer system; and
displaying said net energy efficiency values in a computer system.

2. The method of claim 1, further comprising the step of receiving data in a computer system for the effect of anaerobic digestion.

3. The method of claim 1, wherein the biofuel production system comprises a corn-ethanol production facility

4. The method of claim 1, wherein said receiving data is accomplished with reference data sets.

5. The method of claim 1, wherein said receiving data is accomplished with user-input data for specific conditions at said biofuel production system.

6. The method of claim 1, farther comprising the step of comparing said net energy efficiency values with a predefined standard requirement for net energy efficiency values.

7. A method of determining the natural resource requirements of a biofuel production system, comprising the steps of:
receiving data in a computer system for production parameters of a crop used as a biofuel feedstock, specific characteristics of the biofuel refining system, and use of co-products to feed livestock;
determining said natural resource requirements in a computer system; and
displaying said natural resource requirements in a computer system.

8. The method of claim 7, further comprising the step of receiving data in a computer system for the effect of anaerobic digestion.

9. The method of claim 7, wherein the biofuel production system comprises a corn-ethanol production facility.

10. The method of claim 7, wherein said receiving data is accomplished with reference data sets.

11. The method of claim 7, wherein said receiving data is accomplished with user-input data for specific conditions at said biofuel production system.

12. A method of determining the life cycle greenhouse gas emissions of a biofuel production system, comprising the steps of:
receiving data in a computer system for production parameters of a crop used as a biofuel feedstock, specific characteristics of a biofuel refining system, and use of co-products to feed livestock;
determining said life cycle greenhouse gas emissions in a computer system; and
displaying said life cycle greenhouse gas emissions in a computer system.

13. The method of claim 12, further comprising the step of receiving data in a computer system for the effect of anaerobic digestion.

14. The method of claim 12, wherein the biofuel production system comprises a corn-ethanol production facility.

15. The method of claim 12, wherein said receiving data is accomplished with reference data sets.

16. The method of claim 12, wherein said receiving data is accomplished with user-input data for the specific conditions at said biofuel production system.

17. A computer program product, tangibly stored on a computer readable medium, for determining the net energy efficiency values, natural resource requirements, and life cycle greenhouse gas emissions of a biofuel production system, the product comprising instructions to cause a processor to;
receive data into a computer system for production parameters of a crop used as a biofuel feedstock, specific characteristics of a biofuel refining system, and use of co-products to feed livestock;
determine said net energy efficiency values, natural resource requirements, and life cycle greenhouse gas emissions in a computer system; and
display said net energy efficiency values, natural resource requirements, and life cycle greenhouse gas emissions in a computer system.
